(19) United States
(12) Patent Application Publication
(10) Pub. No.: US 2012/0040137 A1
(43) Pub. Date: Feb. 16, 2012

(54) FIBER COMPOSITE STRUCTURE

(75) Inventors: Maria Palasis, Wellesley, MA (US); Upma Sharma, Somerville, MA (US); Greg Zugates, Chelmsford, MA (US); Daniel Concagh, Newton, MA (US); Toby Freyman, Waltham, MA (US); Quynh Pham, Methuen, MA (US)

(73) Assignee: Arsenal Medical, Watertown, MA (US)

(21) Appl. No.: 13/185,550

(22) Filed: Jul. 19, 2011

Related U.S. Application Data
(60) Provisional application No. 61/368,095, filed on Jul. 27, 2010.

(51) Int. Cl. B32B 3/00; D04H 13/00

(52) U.S. Cl. 428/156; 428/292.1; 428/220

(57) ABSTRACT

Disclosed are fiber composite structures comprising a matrix material and at least one polymeric fiber in contact with the matrix material. The fiber(s) are preferably characterized by a diameter of up to about 20 microns. In certain embodiments, the fiber(s) comprise a therapeutic agent in an amount that exceeds the solubility limit of the therapeutic agent in the fiber polymer. In some embodiments, the fiber(s) comprise an inner radial portion and an outer radial portion.

This application claims the benefit of priority to U.S. Patent Application 61/368,095, filed Jul. 27, 2010, by inventors Maria Palasis et al., entitled “Fiber Composite Structure.”

### FIELD OF THE INVENTION

The present invention relates to fiber composite structures, and more particularly, to fiber composite structures that are useful for adhesion barrier and drug delivery applications.

### SUMMARY OF THE INVENTION

In one aspect, the present invention relates to fiber composite structures that offer desired mechanical properties, and optionally drug delivery characteristics, for medical applications. The fiber composite structures of the present invention comprise a matrix material comprising a polymer, and at least one polymeric fiber in contact with the matrix material.

In another aspect, the present invention relates to tissue adhesion barrier structures fabricated from the fiber composite structures of the present invention.

In another aspect, the present invention relates to methods of making fiber composite structures.

In yet another aspect, the present invention relates to methods of treating patients using the fiber composite structures of the present invention.

In one embodiment, the present invention is a composite structure comprising a matrix material comprising a polymer, and a fiber in contact with the matrix material. The fiber has a diameter of up to about 20 microns, and comprises a first polymeric material and a first therapeutic agent. The amount of the therapeutic agent is greater than the solubility limit of the therapeutic agent in the first polymeric material. The first therapeutic agent preferably makes up at least about 20 weight percent of the fiber.

In another embodiment, the present invention is a tissue adhesion barrier comprising a composite structure. The composite structure comprises a matrix material comprising a polymer, and a fiber in contact with the matrix material. The fiber comprises a first polymeric material preferably having a diameter of up to about 20 microns and a first therapeutic agent. The amount of the therapeutic agent is preferably greater than the solubility limit of the therapeutic agent in the first polymeric material.

In yet another embodiment, the present invention is a method of making a composite structure. The method comprises the steps of providing at least one fiber comprising a polymeric material and a thermally-sensitive drug, forming a polymeric matrix material comprising an acid and an alcohol, contacting the fiber with the polymeric matrix material, and curing the polymeric matrix material at a temperature less than about 120° C. and preferably less than about 50° C. In a preferred embodiment, the polymeric matrix material comprises poly(glycerol sebecate).

### BRIEF DESCRIPTION OF THE DRAWINGS

FIGS. 1a and 1b are schematic representations of side and cross-sectional views of a fiber, respectively, in accordance with an embodiment of the present invention.

FIGS. 2a and 2b are schematic representations of side and cross-sectional views of a fiber, respectively, in accordance with an embodiment of the present invention.

FIG. 3 is a schematic representation of a fiber composite structure, in accordance with an embodiment of the present invention.

FIG. 4 includes scanning electron micrographs of a fiber composite structure in cross-section, in accordance with an embodiment of the present invention. The same structure is shown in FIGS. 4A, B, and C, with FIG. 4A at a low magnification, FIG. 4B at a higher magnification, and FIG. 4C at a yet higher magnification.

FIG. 5 is a schematic representation of a fiber composite structure having raised features, in accordance with an embodiment of the present invention.

FIG. 6 is a schematic representation of a fiber composite structure having cavities, in accordance with an embodiment of the present invention.

### DETAILED DESCRIPTION OF THE PREFERRED EMBODIMENTS

The present invention includes fiber composite structures, methods of making fiber composite structures, implants made from such fiber composite structures, and methods of treating patients using such fiber composite structures. In certain embodiments, the structures of the present invention make use of small fibers with high drug loading rates, and drug release profiles that may be tailored to the specific requirements of a variety of medical applications. As used herein, “drugs” and “therapeutic agents” are used synonymously to include small molecules, biologics, and other active agents used to produce a desired therapeutic effect. In certain embodiments, the fiber composite structures are made using novel low temperature curing processes that allow for the use of thermally-sensitive drugs.

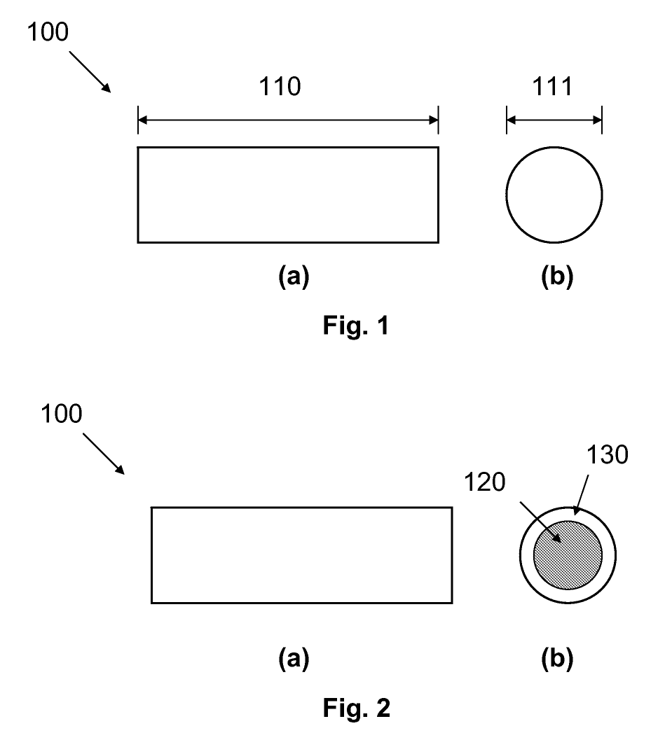

An example of a fiber used within the fiber composite structures of the present invention is shown schematically in FIGS. 1a and 1b. Fiber 100 is generally tubular in shape, and is characterized by a length 110 and a diameter 111. The fibers of the present invention are generally small enough to be useful for implantation to address a wide range of medical applications. As such, the fibers have a diameter 111 that is preferably up to about 20 microns. The length 110 of the fibers is dictated by the intended medical use, and generally may range from microns to millimeters to centimeters.

Fiber 100 is made from any suitable polymeric, biocompatible material and preferably includes a drug embedded therein. Preferably, fiber 100 is made from a bioabsorbable (i.e., biodegradable) material such that it degrades in a patient's body over time following implantation. The rate of degradation of the polymer material used to form the fiber 100 may be designed such that it either degrades following delivery of the drug therefrom, or as a means to control the drug delivery rate via the degradation process.

Examples of bioabsorbable materials that are useful in forming the fiber(s) 100 of the present invention include: polyesters, such as poly(ε-caprolactone) (PCL), poly lactic-co-glycolic acid (PLGA), polyglycolic acid, poly(L-lactic acid), poly(DL-lactic acid); copolymers thereof such as poly(lactide-co-ε-caprolactone), poly(glycolide-co-ε-caprolactone), poly(lactide-co-glycolide), copolymers with polyethylene glycol (PEG); branched polyesters, such as poly(glycerol sebacate); poly(propylene fumarate); poly(ether esters) such as polydioxanone; poly(ortho esters); polyanhydrides such as poly(sebacic anhydride); polycarbonates such as poly(trimethylcarbonate) and related copolymers; polyhydroxyalkanoates such as 3-hydroxybutyrate, 3-hydroxyvalerate and related copolymers that may or may not be biologically derived; polyphosphazenes; poly(amino acids) such as poly(L-lysine), poly(glutamic acid) and related copolymers.

Examples of biologically derived bioabsorbable polymers that are useful in forming fiber(s) 100 of the present invention include: polypeptides such as collagen, elastin, albumin and gelatin; glycosaminoglycans such as hyaluronic acid, chondroitin sulfate, dermatan sulfate, keratan sulfate, heparan sulfate and heparin; chitosan and chitin; agarose; wheat gluten; polysaccharides such as starch, cellulose, pectin, dextran and dextran sulfate; and modified polysaccharides such as carboxymethylcellulose and cellulose acetate. Examples of other dissolvable or resorbable polymers include polyethylene glycol and poly(ethylene glycol-propylene glycol) copolymers that are known as pluronics and reverse pluronics.

Examples of non-biodegradable polymers that are useful in forming the fiber 100 of the present invention include: nylon 4,6; nylon 6; nylon 6,6; nylon 12; polyacrylic acid; polyacrylonitrile; poly(benzimidazole) (PBI); poly(etherimide) (PEI); poly(ethylenimine); poly(ethylene terephthalate); polystyrene; polysulfone; polyurethane; polyurethane urea; polyvinyl alcohol; poly(N-vinylcarbazole); polyvinyl chloride; poly (vinyl pyrrolidone); poly(vinylidene fluoride); poly(tetrafluoroethylene) (PTFE); polysiloxanes; and poly(methyl methacrylate).

In one embodiment as shown schematically in FIGS. 1a and 1b, fiber 100 is substantially homogeneous in composition such that it comprises a uniform polymer composition and drug dispersed substantially uniformly throughout. In a preferred embodiment, however, fiber 100 includes an inner radial portion 120 and outer radial portion 130, as shown in FIGS. 2a and 2b. The use of inner and outer radial portions 120, 130 allows for the tailoring of drug release kinetics. For example, in a preferred embodiment, substantially all of the drug within the fiber 100 is located within the inner radial portion 120 in its as-manufactured condition. In this preferred embodiment, the outer radial portion 130 is substantially free of drug in its as-manufactured condition, and may act as a drug diffusion barrier to control or limit the rate of drug delivery from the inner radial portion 120 into a patient following implantation of the fiber 100, and further serves as a protective layer that may prevent a reaction of the drug during the fiber manufacturing process. In other embodiments, the outer radial portion 130 also includes a drug, which may be the same or different drug as contained in the inner radial portion 120. In yet other embodiments, substantially all of the drug within the fiber 100 is located within the outer radial portion 130, and the inner radial portion 120 is substantially free of drug in its as-manufactured condition. In a preferred embodiment of the invention, the fiber 100 includes inner and outer radial portions 120, 130 as shown in FIGS. 2a and 2b, the total diameter of the fiber is no more than about 20 microns, and the diameter of the outer radial portion is about 1-7 microns larger than the inner radial portion.

In another embodiment, the fiber 100 includes three radial portions: an inner radial portion containing drug and a second radial portion containing polymer (as shown and described for FIGS. 2a and 2b), and further includes an outermost radial portion comprising a polymer that can be subsequently cured into a polymeric matrix material, as described in further detail below.

The amount of drug within the fibers of the present invention is preferably at least about 20 percent by weight. Using the methods of the present invention, the inventors have surprisingly found that high drug loading rates of 20 weight percent and higher (such as 25, 30, 35, 40, 45, 50 weight percent, and higher) may be controllably released in vivo, such as at a linear release rate. To achieve these high drug loading rates, drugs are used that are preferably substantially insoluble in the polymer(s) of the fiber 100 (including any solvents used during the manufacturing process), or the amount of drug that is used is preferably higher than the solubility limit of the drug in the polymer (or solvent). As such, and in contrast with known drug-loaded fiber technologies, the drug will not be dissolved within the polymer and associated solvents, but will exist in particulate form.

The fibers of the present invention are preferably manufactured using electrospinning techniques. Electrospinning is a process in which a continuous stream of polymer solution is ejected from a cylindrical tube or needle known as a “spinneret” towards a collection substrate by the application of both pressure and an electric field. During this process, the charge accumulation and evaporation of the solvent from the solution yields a single, long polymer fiber typically characterized by diameters from the nanometer to micron scale. In a preferred embodiment, fibers of the present invention having inner and outer radial portions are manufactured using a co-axial spinneret system as described in co-pending application Ser. No. 12/620,334, the entire contents of which are incorporated herein by reference.

The drugs used in the fibers of the present invention are any suitable drugs that are selected for treatment of the medical condition for which they are delivered. The drugs are preferably either substantially insoluble in the polymers and solvents used in the fiber 100, or the amount of the drug exceeds the solubility limit of the drug in these materials. General categories of drugs that are useful in the present invention include, but are not limited to: opioids; ACE inhibitors; adenohypophoseal hormones; adrenergic neuron blocking agents; adrenocortical steroids; inhibitors of the biosynthesis of adrenocortical steroids; alpha-adrenergic agonists; alpha-adrenergic antagonists; selective alpha-two-adrenergic agonists; androgens; anti-addictive agents; antiandrogens; antiinfectives, such as antibiotics, antimicrobals, and antiviral agents; analgesics and analgesic combinations; anorexics; antihelminthics; antiarthritics; antiasthmatic agents; anticonvulsants; antidepressants; antidiabetic agents; antidiarrheals; antiemetic and prokinetic agents; antiepileptic agents; antiestrogens; antifungal agents; antihistamines; antiinflammatory agents; antimigraine preparations; antimuscarinic agents; antinauseants; antineoplastics; antiparasitic agents; antiparkinsonism drugs; antiplatelet agents; antiproliferative agents and chemotherapeutics; antiprogestins; antipruritics; antipsychotics; antipyretics; antispasmodics; anticholinergics; antithyroid agents; antitussives; azaspirodecanediones; sympathomimetics; xanthine derivatives; cardiovascular preparations, including potassium and calcium channel blockers, alpha blockers, beta blockers, and antiarrhythmics; antihypertensives; diuretics and antidiuretics; vasodilators, including general coronary, peripheral, and cerebral; central nervous system stimulants; vasoconstrictors; hormones, such as estradiol and other steroids, including corticosteroids; hypnotics; immunosuppressives; muscle relaxants; parasympatholytics; psychostimulants; sedatives; tranquilizers; nicotine and acid addition salts thereof; benzodiazepines; barbiturates; benzothiadiazides; beta-adrenergic agonists; beta-adrenergic antagonists; selective beta-one-adrenergic antagonists; selective beta-two-adrenergic antagonists; bile salts; agents affecting volume and composition of body fluids; butyrophenones; agents affecting calcification; catecholamines; cholinergic agonists; cholinesterase reactivators; dermatological agents; diphenylbutylpiperidines; ergot alkaloids; ganglionic blocking agents; hydantoins; agents for control of gastric acidity and treatment of peptic ulcers; hematopoietic agents; histamines; 5-hydroxytryptamine antagonists; drugs for the treatment of hyperlipiproteinemia; laxatives; methylxanthines; monoamine oxidase inhibitors; neuromuscular blocking agents; organic nitrates; pancreatic enzymes; phenothiazines; prostaglandins; retinoids; agents for spasticity and acute muscle spasms; succinimides; thioxanthines; thrombolytic agents; thyroid agents; inhibitors of tubular transport of organic compounds; drugs affecting uterine motility; anti-vasculogenesis and angiogenesis; vitamins; and the like; or a combination thereof.

Some embodiments of the invention comprise an active component that may include, but is not limited to: a) a corticosteroid, e.g., cortisone, hydrocortisone, prednisolone, beclomethasone propionate, dexamethasone, betamethasone, flumethasone, triamcinolone, triamcinolone acetonide, fluocinolone, fluocinolone acetonide, fluocinolone acetate, clobetasol propionate, or the like, or a combination thereof; b) an analgesic anti-inflammatory agent, e.g., acetaminophen, mefenamic acid, flufenamic acid, indomethacin, diclofenac, diclofenac sodium, alclofenac, ibufenac, oxyphenbutazone, phenylbutazone, ibuprofen, flurbiprofen, ketoprofen, salicylic acid, methylsalicylate, acetylsalicylic acid, 1-menthol, camphor, slindac, tolmetin sodium, naproxen, fenbufen, or the like, or a combination thereof; c) a hypnotic sedative, e.g., phenobarbital, amobarbital, cyclobarbital, lorazepam, haloperidol, or the like, or a combination thereof; d) a tranquilizer, e.g., fulphenazine, thioridazine, diazepam, flurazepam, chlorpromazine, or the like, or a combination thereof; e) an antihypertensive, e.g., clonidine, clonidine hydrochloride, bopinidol, timolol, pindolol, propranolol, propranolol hydrochloride, bupranolol, indenolol, bucumolol, nifedipine, bunitrolol, or the like, or a combination thereof; f) a hypotensive diuretic, e.g., bendroflumethiazide, polythiazide, methylchlorthiazide, trichlormethiazide, cyclopenthiazide, benzyl hydrochlorothiazide, hydrochlorothiazide, bumetanide, or the like, or a combination thereof; g) an antibiotic, e.g., penicillin, tetracycline, oxytetracycline, metacycline, doxycycline, minocycline, fradiomycin sulfate, erythromycin, chloramphenicol, or the like, or a combination thereof; h) an anesthetic, e.g., lydocaine, benzocaine, ethylaminobenzoate, or the like, or a combination thereof; i) another analgesic, e.g., acetylsalicylic acid, choline magnesium trisalicylate, acetaminophen, ibuprofen, fenoprofen, diflusinal, naproxen and the like; j) an antipruritic agent, e.g., bisabolol, oil of chamomile, chamazulene, allantoin, D-panthenol, glycyrrhetenic acid, a corticosteroid, an antihistamines and the like; k) an antimicrobial agent, e.g., methyl hydroxybenzoate, propyl hydroxybenzoate, chlorocresol, benzalkonium chlorides, nitrofurazone, nystatin, sulfacetamide, clotriamazole, or the like, or a combination thereof; l) an antifungal agent, e.g., pentamycin, amphotericin B, pyrrol nitrin, clotrimazole, or the like, or a combination thereof; m) a vitamin, e.g., vitamin A, ergocalciferol, cholecalciferol, octotriamine, riboflavin butyric acid ester, or the like, or a combination thereof; n) an antiepileptic, e.g., nitrazepam, meprobamate, clonazepam, or the like, or a combination thereof; o) an antihistamine, e.g., diphenhydramine hydrochloride, chlorpheniramine, diphenylimidazole, or the like, or a combination thereof; p) an antitussive, e.g., dextromethorphan, terbutaline, ephedrine, ephedrine hydrochloride, or the like, or a combination thereof; q) a sex hormone, e.g., progesterone, estradiol, estriol, estrone, or the like, or a combination thereof r) an antidepressant, e.g., doxepin; s) a vasodilator, e.g., nitroglycerin, isosorbide nitrate, nitroglycol, pentaerythritol tetranitrate, dipyridamole, or the like, or a combination thereof t) local anesthetics, e.g., procaine, benzocaine, chloroprocaine, cocaine, cyclomethycaine, dimethocaine/larocaine, propoxycaine, procaine/novocaine, proparacaine, tetracaine/amethocaine, lidocaine, articaine, bupivacaine, carticaine, cinchocaine/dibucaine, etidocaine, levobupivacaine, lidocaine/lignocaine, mepivacaine, piperocaine, prilocaine, ropivacaine, trimecaine, or the like; u) anti-proliferative or anti-cancer drugs such as paclitaxel, sirolimus, methotrexate, and v) another drug, e.g., 5-fluorouracil, dihydroergotamine, desmopressin, digoxin, methoclopramide, domperidone, scopolamine, scopolamine hydrochloride, or the like, or a combination thereof or the like; or a combination thereof.

Any opioid can be used in the embodiments of the present invention. Useful opioids include, but are not limited to, alfentanil, allylprodine, alphaprodine, anileridine, benzylmorphine, bezitramide, buprenorphine, butorphanol, clonitazene, codeine, desomorphine, dextromoramide, dezocine, diampromide, diamorphone, dihydrocodeine, dihydromorphine, dihydromorphone, dihydroisomorphine, dimenoxadol, dimepheptanol, dimethylthiambutene, dioxaphetyl butyrate, dipipanone, eptazocine, ethoheptazine, ethylmethylthiambutene, ethylmorphine, etonitazene, etorphine, dihydroetorphine, fentanyl, heroin, hydrocodone, hydromorphone, hydromorphodone, hydroxypethidine, isomethadone, ketobemidone, levorphanol, levophenacylmorphan, lofentanil, meperidine, meptazinol, metazocine, methadone, metopon, morphine, myrophine, narceine, nicomorphine, norlevorphanol, normethadone, nalorphine, nalbuphene, normorphine, norpipanone, opium, oxycodone, oxymorphone, pantopon, papavereturn, paregoric, pentazocine, phenadoxone, phendimetrazine, phendimetrazone, phenomorphan, phenazocine, phenoperidine, piminodine, piritramide, propheptazine, promedol, properidine, propoxyphene, propylhexedrine, sufentanil, tilidine, tramadol, pharmaceutically acceptable salts thereof and mixtures of any two or more thereof.

Suitable biologics can be used in the embodiments of the present invention. These include, but are not limited to, anti-inflammatory biologics such as anti-TNF, IL12 or IL23, anti-angiogenic factors, growth factors, growth factor inhibitors, and matrix metalloprotease inhibitors.

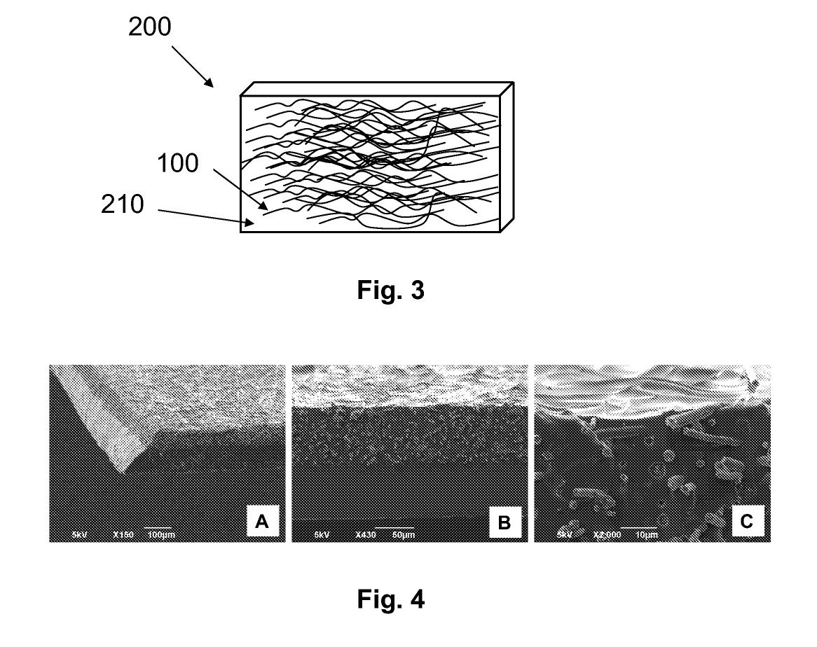

In accordance with the present invention, at least one fiber 100 is placed into contact with a polymeric matrix material to yield a fiber composite structure. Such contact may be, for example, the fiber(s) being embedded within the polymeric matrix material or being applied to one or multiple surfaces thereof. In a preferred embodiment, the fiber(s) are substantially uniformly dispersed throughout the matrix material to yield a structure 200 shown in FIG. 3. The fiber composite structure 200 includes the polymeric matrix material 210 as a continuous phase, and the fiber 100 as a reinforcement phase. The fiber 100 may be one long, continuous fiber or, preferably, numerous short length fibers dispersed throughout the matrix material. In certain embodiments, the fiber 100 includes a therapeutic agent, and fibers with different release rates may be used to achieve different drug release rates within a single structure. It is also possible to tailor drug release characteristics by controlling the length of the fibers 100, as release rate will depend upon fiber surface area and, where the fibers comprise inner and outer radial portions, the rate may differ between the fiber ends and sides.

The polymeric matrix material 210 is any suitable polymeric material or mixtures or copolymers thereof, such as multi-arm polyesters such as poly(glycolide-co-caprolactone) (PGCL), poly(lactide-co-caprolactone) (PLCL), poly(trimethylene carbonate) (PTMC), poly(lactide-co-dioxanone) (PLDO), and copolymers thereof preferably having a glass transition temperature below about body temperature that are optionally crosslinked; linear polyesters such as copolymers of glycolide, lactide, caprolactone, trimethylene carbonate, and dioxanone; poly(glycerol sebacate) (PGS) prepolymer crosslinked with diisocyanate, sebacyl chloride or other diacid chlorides; PGS cured by heating at low temperature (e.g., 45° C.) in the presence of catalysts such as methanesulfonic acid, dibutyl tin dichloride and metal triflates such as scandium triflate and bismuth triflate; photocured PGS prepared from acrylated or methacrylated PGS prepolymer; other elastomers formed by reacting polyols with polyacids or polyacid chlorides; hydrogels such as crosslinked or linear hyaluronic acid and polyethylene glycol (PEG) based gels; and carbohydrates such as dextran and dextran sulfate. Elastomeric polymer matrices provide the advantage in handling and delivery of the fiber composite structure to the body site of interest, and form conformal contacts with tissue surfaces of interest.

In one aspect, the present invention relates to a method of making fiber composite structures. In a preferred embodiment, fiber composite structures are made by a method that comprises the steps of providing at least one fiber comprising a polymeric material and a thermally-sensitive drug; forming a polymeric matrix material comprising an acid and an alcohol; contacting the fiber(s) with the polymeric matrix material; and curing the polymeric matrix material at low temperatures. A preferred example of a polymeric material comprising an acid and an alcohol that is useful in the practice of the present invention is PGS. The low temperature (i.e., less than about 120° C., and preferably less than about 50° C.) curing of such polymeric matrix materials allows for the use of thermally-sensitive drugs, which at least partially decompose at temperatures greater than body temperature and less than about 140° C. By curing at low temperatures, the structure and efficacy of thermally-sensitive drugs is preserved. For example, if a drug is stable up to about 70° C., a preferred curing process is one that occurs below about 70° C. In some cases, a curing process at a temperature close to the stability limit of the drug is preferred because of processing considerations, such as reduced level of required catalyst or reduced curing time. It is further preferred that such polymeric matrix materials are characterized by a low glass transition temperature, preferably below room temperature, and low molecular weight such that they can be classified as oligomers or polymers with molecular weights preferably less than about 10 kDa, which allows for the handling of these materials as viscous liquids. As such, they can be poured into molds for contact with fibers, which are embedded or encapsulated within the resulting polymer films. Upon subsequent curing, the polymer becomes a solid with fibers encased therein.

In embodiments in which the polymeric matrix material 210 is made from PGS, the inventors have developed a novel low temperature curing process for the manufacture of PGS films. In this process, PGS prepolymer may be dissolved in an organic solvent (such as, for example, dichloromethane, tetrahydrofuran, or acetone) and mixed with sebacyl chloride. The solution is then placed into a mold and cured, with subsequent evaporation of the solvent to yield cured PGS films. Optionally, the resulting structure is contacted with a non-solvent for PGS (such as, for example, ether or hexane) containing sebacyl chloride, which crosslinks the PGS by diffusion and penetration into the prepolymer, followed by reaction with the prepolymer to bring about crosslinking and curing.

In another embodiment, PGS prepolymer is synthesized from dimethyl sebecate, which will cure at lower temperatures than PGS prepolymer made with sebacic acid because the release of methanol in the former occurs at lower temperatures than the release of water in the latter. Optionally, catalysts are added to accelerate the rate of cross-linking at lower temperatures.

In another embodiment, PGS prepolymer is functionalized with UV-reactive groups, such as acrylate or methacrylate groups, and crosslinked at room temperature by application of UV light and/or microwave energy.

In yet another embodiment, fiber composite structures comprise aqueous emulsions dispersed within a polymer matrix. The emulsion is optionally formed in the prepolymer stage, and crosslinked using room temperature curing methods as previously described. The emulsions may be stabilized with surfactants such as polyvinyl alcohol or poloxamers, and comprise biologics for delivery.

In a preferred embodiment, the fiber composite structure 200 is in the form of a sheet or a patch that is suitable for medical applications such as a tissue adhesion barrier. An example of a fiber composite structure of the present invention in the form of a sheet that is useful as a tissue adhesion barrier is shown in FIG. 4, which structure includes, for example, PLGA fibers in a PGS matrix. Such adhesion barriers are placed between tissues following abdominal or pelvic surgical procedures to prevent unwanted adhesions upon tissue healing. Such adhesions can lead to post-surgical morbidity complications. When used as adhesion barriers, the composite structures of the present invention offer improved mechanical and physical properties compared with conventional adhesion barriers or those composed of PGS only, thus leading to improved handling, deployment, and treatment of target sites. In addition, when used for drug delivery, the composite structures of the present invention allow for controlled drug release rates and substantially decouple the drug release properties from the mechanical and physical properties of the adhesion barrier. Other applications include the treatment and/or prevention of adhesions forming in other anatomical locations (e.g., spine, joints, heart, etc.); treatment of dermal wounds, including combat wounds to the abdomen; and treatment of diseases such as cancer, either as a standalone device or in combination with surgical or minimally-invasive tumor resection.

In a preferred embodiment, when the fiber composite structure 200 is formed as a sheet for application as a tissue adhesion barrier, both the fiber 100 and the polymeric matrix material 210 are made from fully biodegradable materials. The thickness of the sheet is within the range of about 20 microns to about 2 millimeters, preferably about 100 microns. In this preferred embodiment, the fiber 100 is formed through a co-axial electrospinning process to yield a structure comprising an inner radial portion and an outer radial portion. The outer radial portion comprises PLGA (preferably 50:50 d,l-PLGA) and the inner radial portion comprises PLGA (preferably 50:50 d,l-PLGA) and dexamethasone as the therapeutic agent. The polymeric matrix material 210 comprises poly(glycerol sebacate) (PGS). The dexamethasone is preferably released from the structure 200 at a substantially constant rate, and for a time period of up to about 30 days after application to a surgical site. The fiber 100 and the polymeric matrix material 210 are preferably formulated such that they fully degrade within about 30 days after application to a surgical site.

The fiber composite structures of the present invention are made by any suitable process. For example, electrospun fibers are formed into a patch or the like using the processes described in co-pending U.S. Ser. No. 12/620,334, and the polymeric matrix material is sprayed over the fibers to yield a fiber composite structure. In another embodiment, the patch (or other fiber structure) is dipped into the polymeric matrix material. In another embodiment, a “sandwich” structure is produced by placing a cured polymeric material over a larger electrospun fiber patch, and electrospinning a fiber layer over the polymeric material to yield intertwined fiber around an encapsulated polymeric matrix core. In another embodiment, a reverse sandwich structure is produced by placing an electrospun fiber patch between two cured polymeric matrix layers, and joining the polymeric matrix layers using a crosslinker or using additional polymeric material to be cured. In another embodiment, fibers are electrospun directly onto a cured polymeric matrix sheet, which adheres to the fibers by a patterned or textured surface or through lithography techniques. In yet other embodiments, fibers are manufactured with a polymer coating or overlayer (e.g., of PGS) that cures the fibers into a composite structure without the need for a separate polymeric matrix material structure.

When used as a tissue adhesion barrier, the fiber composite structure 200 of the present invention optionally includes one or more patterned surfaces to increase the surface area of interaction with tissues. Such patterned surfaces may serve to increase surface roughness to thereby increase frictional forces with surrounding tissues, thus limiting motion of the barrier when positioned within a surgical site.

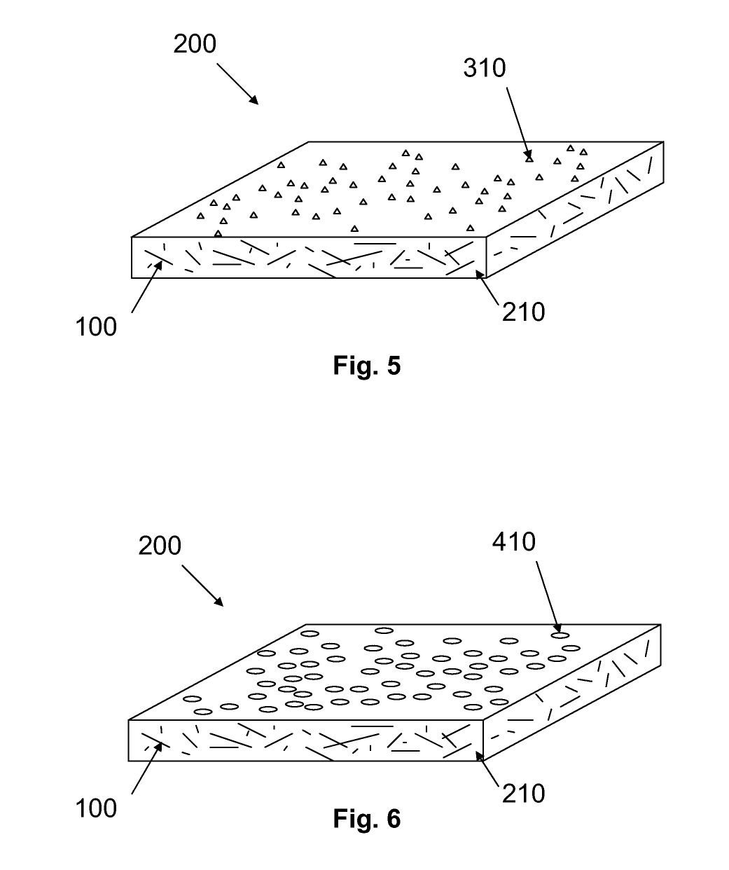

In one embodiment, the structure 200 includes raised features 310 as shown in FIG. 5. The raised features 310 are of any suitable shape such as cylinders, and are preferably about 1 to 100 microns in length (i.e., extending from the surface of the structure 200), more preferably about 10 to 30 microns. The raised features 310 may be randomly arranged on one or both surfaces of structure 200, or are preferably arranged in a regular, repeating pattern such as a checkerboard, rows, concentric circles, radial lines, and herringbone patterns. The raised features 310 are formed by any suitable technique, such as by coating one or both surfaces of the structure 200 and removing or etching away the material between the features 310. Preferably, the raised features 310 are formed by depositing a polymer material onto the surface(s) of the structure 200. For example, hyaluronic acid may be deposited onto the structure 200 and thereafter crosslinked to assist in binding the hyaluronic acid raised features 310 to the material of the structure 200. Other materials that may be used to form the raised features 310 include chitosan, various Carbopol derivatives, hydroxypropylcellulose, hydroxyethylcellulose, alginate, gelatin, carrageenan, polymethacrylic acid, polyacrylic acid, any thiolated derivatives of the previously mentioned materials made, for example, by reaction with 2-iminothiolane or cysteine conjugation, and any materials generally regarded as mucoadhesives. These materials are optionally crosslinked with agents such as carbodiimides (e.g., 1-ethyl-3-(3-dimethylaminopropyl)carbodiimide [EDC], N,N′-diisopropylcarbodiimide [DIC], N,N′-dicyclohexylcarbodiimide [DCC]), carbonyldiimidazole (CDI), disuccinimidyl carbonate (DSC), N-ethyl-5-phenylisoxazolium 3′-sulfonate (Woodward's reagent K), diisocyanates (e.g., hexamethylenediisocyanate [hdi], lysine diisocyanate [LDI], and bis-N-hydroxysuccimide esters (e.g., disuccinimidyl glutarate, ethylene glycolbis(succinimidyl succinate)). Alternatively, when PGS or a similar polymer is used as the polymeric matrix material 210, the raised features 310 are formed during the crosslinking reaction by contacting the PGS prepolymer film with a non-polar solvent, such as pentane or cyclohexane containing sebacyl chloride. The raised features form spontaneously due to the polarity differences between PGS and the solvent. Mucoadhesives are optionally deposited into spaces or crevices between the raised features, thus providing protection of the adhesive until such time as the structure 200 is placed in vivo, where the adhesive may dissolve, swell, or be mechanically pressed into contact with tissue.

In another embodiment, the structure 200 includes cavities 410 as shown in FIG. 6. The cavities 410 may be of any suitable cross-sectional shape, such as circular, square, rectangular, triangular, elliptical, polygonal, or irregular. The cavities optionally contain a hydrogel or hyaluronic acid, which, when placed into the body, interacts with water and other bodily fluids to swell and therefore protrude from the surface of the structure 200. In this embodiment, the cavities have an exemplary cross-sectional dimension of between about 1 and 100 microns, and an exemplary depth of between about 1 and 500 microns. Alternatively, the cavities may extend through the entire thickness of the structure 200. When employed, the hydrogel or hyaluronic acid preferably occupies between about 10 to 80% of the cavity depth. The spacing between cavities may be from microns to several millimeters, depending upon the application. The advantage of this design when used as an adhesion barrier is that the structure 200 does not have a hyaluronic acid exposed on the surface upon application to a surgical site, thus allowing for repositioning. After some period of time of exposure to bodily fluids, however, the hydrogel or hyaluronic acid within the cavities 410 expands and therefore protrudes above the surface(s) of the structure 200 to yield a patterned surface, thus limiting motion of the barrier when positioned at the final, desired position within the body. Alternatively or in addition, the cavities 410 may contain a suitable adhesive for adhering the structure 200 to tissue. In one embodiment, the cavities 410 contain such an adhesive and the surface of the structure 200 is covered with a polymer that dissolves in vivo within seconds to minutes after exposure to bodily fluids to expose the adhesive for adhesion to tissue. In this embodiment, the time for dissolution of the polymer covering the surface of the structure 200 may be useful for the repositioning of structure 200 immediately prior to adhesion to tissue.

### EXAMPLES

Aspects and embodiments of the present invention are described with reference to the following non-limiting examples.

### Example 1

### Synthesis of PGS Prepolymer

In a 500 ml three-neck round bottom flask equipped with a condenser, 92.4 g of glycerol was added to 202.9 g of sebacic acid. The mixture was heated to at 120° C. under a nitrogen atmosphere for 24 hours, and then placed under high vacuum (1-5 mTorr) for an additional 20 hours. The prepolymer was cooled to room temperature for use as a matrix material in an embodiment of the present invention.

### Example 2

### Curing and Testing of PGS Films

950 mg of the PGS prepolymer formed in accordance with Example 1 was dissolved in 3 ml of dichloromethane. 345 μl of sebacyl chloride was added to the solution, which was mixed and poured into an aluminum pan. After evaporation of the dichloromethane, dogbones were cut from the resulting film and the mechanical properties were measured on an Instron testing machine. Samples were found to have the following approximate average properties: modulus of elasticity—60 kPa; break stress—200 kPa; elongation to break—477%.

### Example 3

### Curing of PGS Films Containing Electrospun PLGA Using Sebacyl Chloride

300 mg of the PGS prepolymer formed in accordance with Example 1 was dissolved in 2 ml of tetrahydrofuran (THF) and poured into an aluminum pan, which was covered with foil. After evaporation of the THF overnight, the pan was heated to 60° C. for 3 hours, and then cooled to room temperature. Discs of 1 cm diameter were punched from an electrospun 10:90 PLGA fiber mesh and placed onto the PGS prepolymer film, which was then melted at 35° C. so that the PLGA fiber mesh discs were embedded into the PGS. Keeping the PGS at 35° C., 18 ml of ether containing 60 μl of sebacyl chloride was added over the PGS surface and the pan was covered with foil for 75 minutes, and then uncovered for an additional 15 minutes to yield a cured PGS film containing electrospun PLGA fiber mesh.

### Example 4

### Curing of PGS Films Containing Electrospun PLGA Using Triflate Catalyst

300 mg of the PGS prepolymer formed in accordance with Example 1 was dissolved in 2.8 ml of tetrahydrofuran (THF). 2.95 mg of scandium triflate was dissolved in 1 ml of THF, and 200 μl of this solution was added to the PGS solution. The solution was well-mixed and poured into an aluminum pan, and then covered with foil for 5 hours and heated at 60° C. for 30 minutes. After cooling to room temperature, 1 cm discs of electrospun 85:15 PLGA fiber mesh were added to the PGS surface. The pan was placed in a 60° C. oven under high vacuum (6-8 mTorr) for approximately 64 hours to fully cure the PGS.

### Example 5

### Curing of PGS Films Containing PLGA Scaffolds Using Methanesulfonic Acid Catalyst

350 mg of the PGS prepolymer formed in accordance with Example 1 and 1.75 mg of methanesulfonic acid (MSA) were dissolved in 5 mg of anhydrous tetrahydrofuran. The solution was poured into an aluminum pan, and the solvents were evaporated at room temperature. The residue was cured in either of a convention oven at 60° C. for 24 hours or in a vacuum oven (6-8 mTorr) at 45° C. for 48 hours. Under either curing condition, tacky-free elastic PGS films were obtained.

### Example 6

### Curing of PGS Films Containing Dexamethasone-Loaded Electrospun PLGA Scaffolds

PGS films were made in accordance with Example 5, except that prior to curing, dexamethasone-loaded electrospun 10:90 PLGA fiber meshes were embedded into the PGS/MSA mixture. Curing was conducted at two different temperatures—45° C. and 60° C.—after which the dexamethasone was chemically recovered from the films. 91.8% of dexamethasone was recovered after the 45° C. curing treatment, while only 26.1% of dexamethasone was recovered after the 60° C. curing treatment, thus demonstrating the greater compatibility of the lower temperature curing condition with dexamethasone.

The present invention provides novel fiber composite structures that are useful for adhesion barrier and drug delivery applications, and novel methods of making fiber composite structures. While aspects of the invention have been described with reference to example embodiments thereof, it will be understood by those skilled in the art that various changes in form and details may be made therein without departing from the scope of the invention.

We claim:

1. A composite structure, comprising:
a matrix material comprising a first bioabsorbable polymer; and
a fiber in contact with said matrix material, said fiber comprising a second bioabsorbable polymer and a therapeutic agent.

2. The composite structure of claim 1, wherein said first bioabsorbable polymer is the same polymer as said second bioabsorbable polymer.

3. The composite structure of claim 1, wherein said first bioabsorbable polymer is a different polymer than said second bioabsorbable polymer.

4. The composite structure of claim 1, wherein said fiber has a diameter up to 20 microns.

5. The composite structure of claim 1, wherein said fiber is substantially homogeneous in composition.

6. The composite structure of claim 1, wherein said fiber comprises an inner radial portion and an outer radial portion.

7. The composite structure of claim 6, wherein said therapeutic agent is located within said inner radial portion.

8. The composite structure of claim 7, wherein said outer radial portion is substantially free of drug in an as-manufactured condition.

9. The composite structure of claim 1, wherein said therapeutic agent is substantially insoluble in said second bioabsorbable polymer.

10. The composite structure of claim 9, wherein the amount of said therapeutic agent in said fiber is at least 20 weight percent.

11. The composite structure of claim 1, wherein said fiber is embedded within said matrix material.

12. The composite structure of claim 1, wherein said fiber is applied to a surface of said matrix material.

13. The composite structure of claim 1, wherein said structure comprises a plurality of fibers, each of said plurality of fibers comprising a bioabsorbable polymer and a therapeutic agent.

14. The composite structure of claim 13, wherein all of said plurality of fibers comprise the same bioabsorbable polymer.

15. The composite structure of claim 13, wherein all of said plurality of fibers comprise the same therapeutic agent.

16. The composite structure of claim 13, wherein at least one fiber within said plurality of fibers comprises a bioabsorbable polymer that is different from another of said fibers within said plurality of fibers.

17. The composite structure of claim 13, wherein at least one fiber within said plurality of fibers comprises a therapeutic agent that is different from another of said fibers within said plurality of fibers.

18. The composite structure of claim 13, wherein said plurality of fibers are substantially uniformly dispersed throughout said matrix material.

19. The composite structure of claim 13, wherein said plurality of fibers are configured as a mesh.

20. The composite structure of claim 1, wherein said matrix material is in the form of a sheet.

21. The composite structure of claim 20, wherein said sheet has a thickness between 20 microns and 2 millimeters.

22. The composite structure of claim 20, wherein said sheet comprises raised features.

23. The composite structure of claim 20, wherein said sheet comprises cavities.
